(19) United States
(12) Patent Application Publication
(10) Pub. No.: US 2023/0146168 A1
(43) Pub. Date: May 11, 2023

(54) Numbering Stencil Assembly

(71) Applicant: Eric Gutierrez, Las Vegas, NV (US)

(72) Inventor: Eric Gutierrez, Las Vegas, NV (US)

(21) Appl. No.: 17/522,248

(22) Filed: Nov. 9, 2021

(51) Int. Cl. B41F 15/36

(52) U.S. Cl. CPC B41F 15/36

(57) ABSTRACT

A numbering stencil assembly for painting numbers or words on a curb includes a frame that is positionable against an exposed face of a curb to define a painting area on the exposed face. A pair of first mating members is provided and each of the first mating members is coupled to the frame. A plurality of stencils is provided and respective stencils are positionable on the frame to facilitate words or numbers to be painted onto the exposed face of the curb. A plurality of second mating members is provided and each of the second mating members is coupled to a respective one of the stencils. Each of the second mating members on respective ones of the stencils releasably engages the first mating members on the frame when the respective stencils are positioned on the frame for retaining the respective stencils on the frame.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to stencil device and more particularly pertains to a new stencil device for painting numbers or words on a curb. The device includes a frame the can be positioned on an exposed face of a curb and a pair of first mating members that are attached to the frame. The device includes a plurality of stencils and a plurality of second mating members that are attached to respective stencils. A selected combination of stencils can be attached to the frame to facilitate numbers or words to be accurately painted on the curb.

(2) Description of Related Art including Information Disclosed under 37 CFR 1.97 and 1.98

The prior art relates to stencil devices including a stencil device that includes a mount which includes a first portion hingedly coupled to a second portion which can be positioned over a curb and a plurality of stencils that are attachable to the mount for painting indicia on the curb. The prior art discloses a stencil device that includes panel that has a pair of rails straddling a slot in the panel and a plurality of stencils that can be slid into the rails. The prior art discloses a stencil device that includes a cart and a pair of stencil wheels that are rotatably disposed on the cart for painting markings on parking lots. The prior art discloses a stencil device that includes a frame into which a plurality of stencils can be positioned and a plurality of spacers that are insertable into the frame for occupying empty space in the frame.

### BRIEF SUMMARY OF THE INVENTION

An embodiment of the disclosure meets the needs presented above by generally comprising a frame that is positionable against an exposed face of a curb to define a painting area on the exposed face. A pair of first mating members is provided and each of the first mating members is coupled to the frame. A plurality of stencils is provided and respective stencils are positionable on the frame to facilitate words or numbers to be painted onto the exposed face of the curb. A plurality of second mating members is provided and each of the second mating members is coupled to a respective one of the stencils. Each of the second mating members on respective ones of the stencils releasably engages the first mating members on the frame when the respective stencils are positioned on the frame for retaining the respective stencils on the frame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a numbering stencil assembly according to an embodiment of the disclosure.

FIG. 2 is an exploded perspective view of an embodiment of the disclosure.

FIG. 3 is a front perspective view of an embodiment of the disclosure.

FIG. 4 is a perspective in-use view of an embodiment of the disclosure showing indicia being painted onto a curb.

FIG. 5 is a perspective view of an embodiment of the disclosure showing indicia having been painted onto a curb.

### DETAILED DESCRIPTION OF THE INVENTION

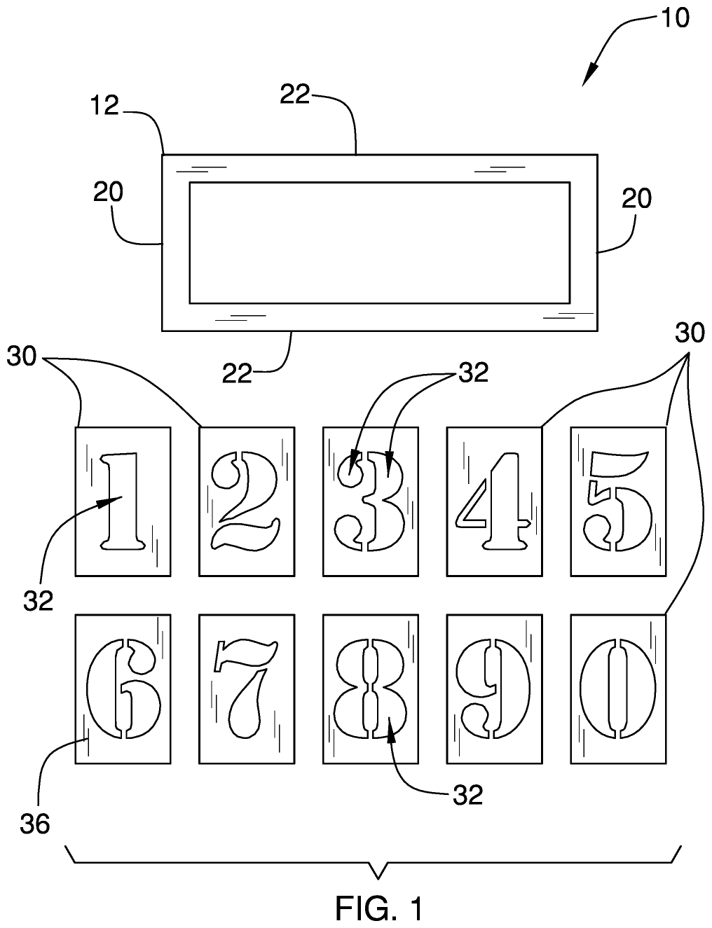

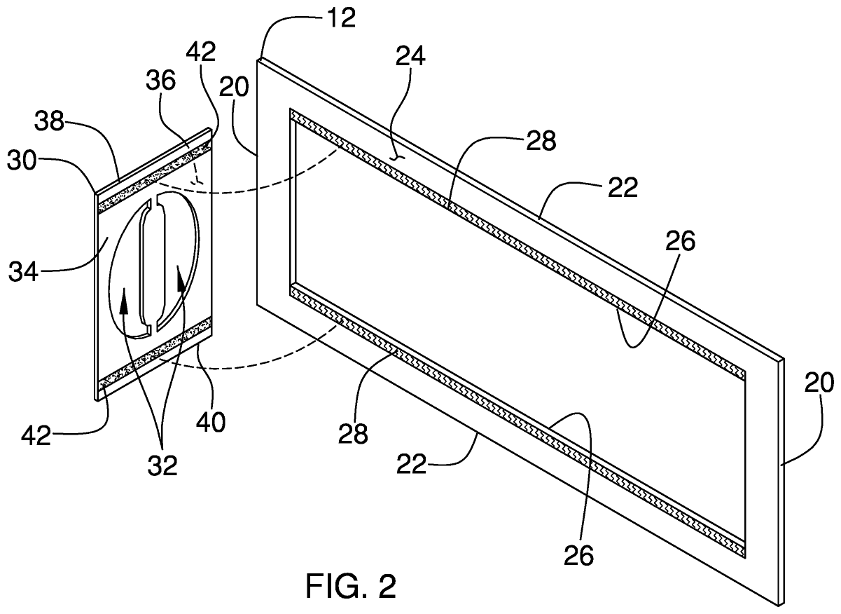

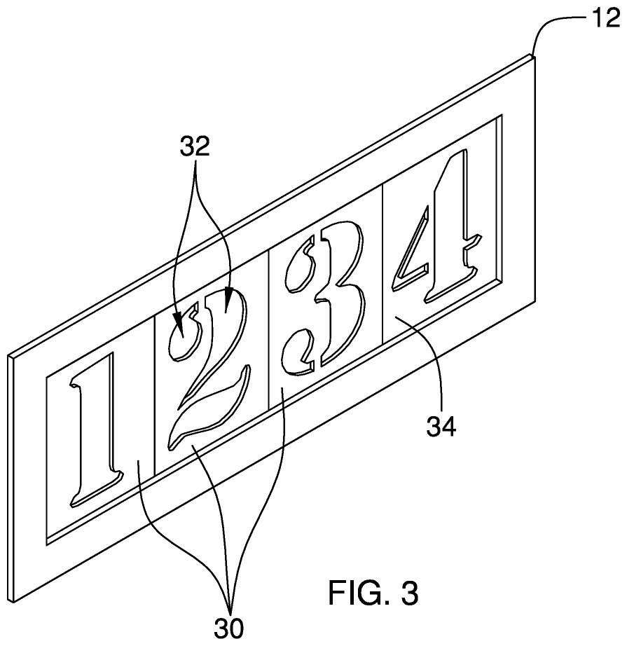

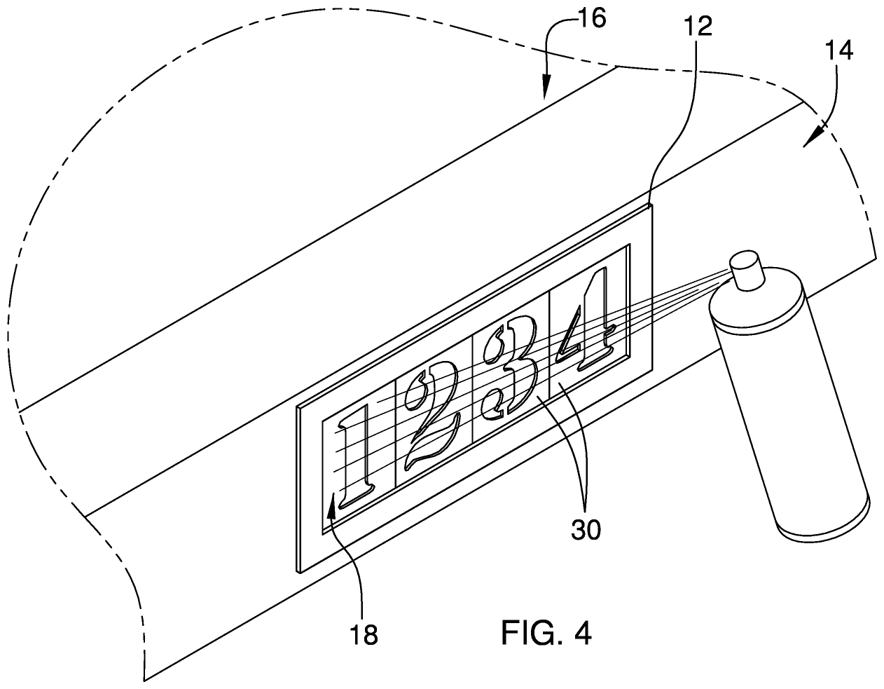

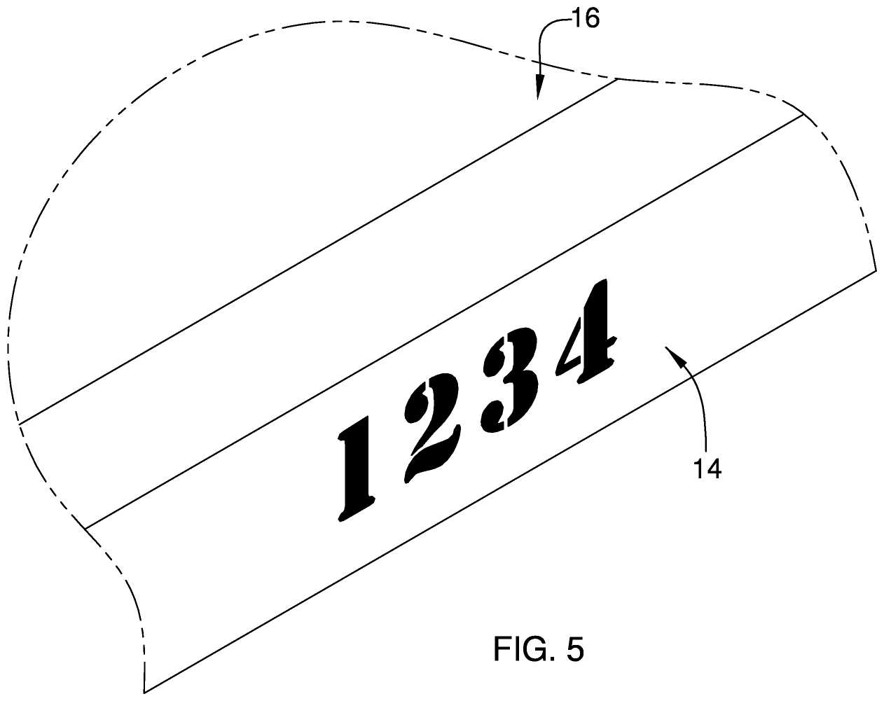

With reference now to the drawings, and in particular to FIGS. 1 through 5 thereof, a new stencil device embodying the principles and concepts of an embodiment of the disclosure and generally designated by the reference numeral 10 will be described.

As best illustrated in FIGS. 1 through 5, the numbering stencil assembly 10 generally comprises a frame 12 that is positionable against an exposed face 14 of a curb 16 to define a painting area 18 on the exposed face 14. The curb 16 may be a gutter curb on a public roadway or other type of curb. The frame 12 has a pair of first arms 20 that each extends between a pair of second arms 22. The first arms 20 are spaced apart from each other such that the frame 12 has a rectangular shape and each of the second arms 22 has a length that is greater than the length of the first arms 20. Each of the second arms 22 has a back surface 24 and a first edge 26 extending between each of the first arms 20. In this way the back surface 24 is exposed when the frame 12 is positioned against the exposed face 14 of the curb 16. Furthermore, the first edge 26 of each of the second arms 22 is directed toward each other. Each of the first arms 20 may have a length ranging between approximately 6.0 inches and 8.0 inches. Additionally, each of the second arms 22 may have a length ranging between approximately 15.0 inches and 17.0 inches.

A pair of first mating members 28 is provided and each of the first mating members 28 is coupled to the frame 12. Each of the first mating members 28 is positioned on the back surface 24 of a respective one of the second arms 22 and each of the first mating members 28 is aligned with the first edge 26 of the respective second arm 22. Additionally, each of the first mating members 28 is coextensive with the first edge 26 of the respective second arm 22. Each of the first mating members 28 may comprise a hook portion of a hook and loop fastener or other type of multiple use, releasable fastener.

A plurality of stencils 30 is provided and each of the stencils 30 has a plurality of openings 32 each extending through the stencils 30. Each of the openings 32 in each of the stencils 30 is structured and arranged to define a respective letter or number. The respective letter may be a letter of the Latin alphabet or any other alphabet that is employed to represent spoken languages throughout the world. Additionally, the respective number may be an Arabic numeral or other numeral employed in written languages throughout the world. Respective ones of the stencils 30 are positionable on the frame 12 to facilitate words or numbers to be painted onto the exposed face 14 of the curb 16.

Each of the stencils 30 has a front side 34, a back side 36, a top edge 38 and a bottom edge 40, and each of the openings 32 in each of the stencils 30 extends through the front side 34 and the back side 36. Respective ones of the stencils 30 are positionable against the frame 12 such that the back side 36 of the respective stencils 30 abuts the back surface 24 of the second arms 22 of the frame 12. Additionally, the respective stencils 30 are distributed along the second arms 22 of the frame 12. A plurality of second mating members 42 is provided and each of the second mating members 42 is coupled to a respective one of the stencils 30. Each of the second mating members 42 on respective ones of the stencils 30 releasably engages the first mating members 28 on the frame 12 when the respective stencils 30 are positioned on the frame 12. In this way the respective stencils 30 are retained on the frame 12.

Each of the second mating members 42 on the respective stencils 30 is positioned on the front side 34 of the respective stencils 30. Furthermore, each of the second mating members 42 on the respective stencils 30 is positioned adjacent to a respective one of the top edge 38 and the bottom edge 40 of the respective stencils 30. Each of the second mating members 42 on the respective stencils 30 extends along a full length of the top edge 38 and the bottom edge 40 of the respective stencils 30. Additionally, each of the second mating members 42 may comprise a loop portion of a hook and loop fastener or other type of multiple use, releasable fastener.

In use, selected stencils 30 are positioned on the back surface 24 of the second arms 22 such that the second mating members 42 on the stencils 30 engage the first mating members 28 on the frame 12. The frame and the selected stencils 30 are positioned against the exposed surface 14 of the curb 16. In this way the stencils 30 can be accurately positioned on the exposed face 14 of the curb 16 for spray painting a street address, for example, on the exposed face 14 of the curb 16. Additionally, the stencils 30 can be combined in nearly endless combinations on the frame 12 to form words and numbers.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A numbering stencil assembly for painting indicia on a curb, said assembly comprising:
a frame being configured to be positionable against an exposed face of the curb wherein said frame is configured to define a painting area on the exposed face;
a pair of first mating members, each of said first mating members being coupled to said frame;
a plurality of stencils, each of said stencils having a plurality of openings each extending through said stencils, each of said openings in each of said stencils being structured and arranged to define a respective letter or number, respective ones of said stencils being positionable on said frame having said openings in said respective stencils being aligned with said painting area on the curb wherein said respective stencils are configured to facilitate words or numbers to be painted onto the exposed face of the curb;
a plurality of second mating members, each of said second mating members being coupled to a respective one of said stencils, each of said second mating members on respective ones of said stencils releasably engaging said first mating members on said frame when said respective stencils are positioned on said frame for retaining said respective stencils on said frame; and
said respective ones of said stencils being configured to be positioned between said frame and the curb when mated to said frame and said frame is positioned against the exposed face of the curb.

2. The assembly according to claim 1, wherein:
said frame has a pair of first arms each extending between a pair of second arms, said first arms being spaced apart from each other such that said frame has a rectangular shape, each of said second arms having a length being greater than the length of said first arms, each of said second arms having a back surface, a front surface, and a first edge extending between each of said first arms wherein said front surface is configured to be exposed when said frame is positioned against the exposed face of the curb, said first edge of each of said second arms being directed toward each other; and
each of said first mating members is positioned on said back surface of a respective one of said second arms, each of said first mating members being aligned with said first edge of said respective second arm, each of said first mating members being coextensive with said first edge of said respective second arm.

3. The assembly according to claim 1, wherein:
each of said stencils has a front side, a back side, a top edge and a bottom edge, each of said openings in each of said stencils extending through said front side and said back side, respective ones of said stencils being positionable against said frame such that said front side of said respective stencils abuts said back surface of said second arms of said frame, said respective stencils being distributed along said second arms of said frame; and
each of said second mating members on said respective stencils is positioned on said front side of said respective stencils, each of said second mating members on said respective stencils being positioned adjacent to a respective one of said top edge and said bottom edge of said respective stencils, each of said second mating members on said respective stencils extending along a full length of said top edge and said bottom edge of said respective stencils.

4. A numbering stencil assembly for painting indicia on a curb, said assembly comprising:
a frame being configured to be positionable against an exposed face of the curb wherein said frame is configured to define a painting area on the exposed face, said frame having a pair of first arms each extending between a pair of second arms, said first arms being spaced apart from each other such that said frame has a rectangular shape, each of said second arms having a length being greater than the length of said first arms, each of said second arms having a back surface, a front surface, and a first edge extending between each of said first arms wherein said front surface is configured to be exposed when said frame is positioned against the exposed face of the curb, said first edge of each of said second arms being directed toward each other;
a pair of first mating members, each of said first mating members being coupled to said frame, each of said first mating members being positioned on said back surface of a respective one of said second arms, each of said first mating members being aligned with said first edge of said respective second arm, each of said first mating members being coextensive with said first edge of said respective second arm;
a plurality of stencils, each of said stencils having a plurality of openings each extending through said stencils, each of said openings in each of said stencils being structured and arranged to define a respective letter or number, respective ones of said stencils being positionable on said frame having said openings in said respective stencils being aligned with said painting area on the curb wherein said respective stencils are configured to facilitate words or numbers to be painted onto the exposed face of the curb, each of said stencils having a front side, a back side, a top edge and a bottom edge, each of said openings in each of said stencils extending through said front side and said back side, respective ones of said stencils being positionable against said frame such that said front side of said respective stencils abuts said back surface of said second arms of said frame, said respective stencils being distributed along said second arms of said frame; and
a plurality of second mating members, each of said second mating members being coupled to a respective one of said stencils, each of said second mating members on respective ones of said stencils releasably engaging said first mating members on said frame when said respective stencils are positioned on said frame for retaining said respective stencils on said frame, each of said second mating members on said respective stencils being positioned on said front side of said respective stencils, each of said second mating members on said respective stencils being positioned adjacent to a respective one of said top edge and said bottom edge of said respective stencils, each of said second mating members on said respective stencils extending along a full length of said top edge and said bottom edge of said respective stencils, wherein said respective ones of said stencils are configured to be positioned between said frame and the curb when mated to said frame and said frame is positioned against the exposed face of the curb.
